(19) United States
(12) Patent Application Publication
(10) Pub. No.: US 2020/0082590 A1
(43) Pub. Date: Mar. 12, 2020

(54) VEHICLE AND CONTROL METHOD THEREOF

(71) Applicants: HYUNDAI MOTOR COMPANY, Seoul (KR); KIA MOTORS CORPORATION, Seoul (KR)

(72) Inventors: Seunghyun WOO, Seoul (KR); Seok-young YOUN, Seoul (KR); Jimin HAN, Anyang-si (KR); Jia LEE, Uiwang-si (KR); Kye Yoon KIM, Gunpo-si (KR)

(21) Appl. No.: 16/213,459

(22) Filed: Dec. 7, 2018

(30) Foreign Application Priority Data
Sep. 11, 2018 (KR) 10-2018-0108088

(51) Int. Cl. G06T 13/40; G06K 9/00; G06F 3/01

(52) U.S. Cl. CPC G06T 13/40; G06F 3/015; G06K 9/00302

(57) ABSTRACT

Disclosed is a vehicle and control method thereof, which updates the facial expression of an avatar based on the emotion of a user. The vehicle includes a detector configured to detect at least one of a biological signal of a user and a behavior of the user; a storage configured to store previous emotion information of the user and facial expression information of an avatar; a controller configured to obtain current emotion information indicating a current emotional state of the user based on at least one of the biological signal of the user and the behavior of the user, and compare the previous emotion information and the current emotion information to update the facial expression information; and a display configured to display the avatar based on the updated facial expression information.

### CROSS-REFERENCE TO RELATED APPLICATION

This application is based on and claims priority under 35 U.S.C. § 119 to Korean Patent Application No. 10-2018-0108088 filed on Sep. 11, 2018, in the Korean Intellectual Property Office, the disclosure of which is incorporated herein by reference in its entirety.

### TECHNICAL FIELD

The present disclosure relates to a vehicle and control method thereof, which displays an avatar based on emotion of a user.

### BACKGROUND

Vehicles equipped with artificial intelligence (AI) and capable of interacting with users are emerging these days.

Conventional vehicles, however, give one-sided feedback to the users without considering the situation and emotion of the users while interacting with the users, which might give the users uncomfortable experience.

Furthermore, when giving such one-sided feedback, the vehicles may uniformly maintain feedback elements, which might be unfriendly to the users.

Accordingly, a need exists for a technology for a vehicle capable of interacting with a user to provide feedback for the user in more empathetic and friendly ways.

### SUMMARY

The present disclosure provides a vehicle and control method thereof, which updates the facial expression of an avatar based on the emotion of a user.

In accordance with an aspect of the present disclosure, a vehicle is provided. The vehicle includes a detector configured to detect at least one of a biological signal of a user and a behavior of the user; a storage configured to store previous emotion information of the user and facial expression information of an avatar; a controller configured to obtain current emotion information indicating a current emotional state of the user based on at least one of the biological signal of the user and the behavior of the user, and compare the previous emotion information and the current emotion information to update the facial expression information; and a display configured to display the avatar based on the updated facial expression information.

The facial expression information may include position and angle information of face elements of the avatar, and the face elements may include at least one of eyebrows, eyes, eyelids, nose, mouth, lips, cheeks, dimple, and chin of the avatar.

The controller may update the facial expression information of the avatar to correspond to an emotion indicated by the current emotion information, in response to a determination by the controller that relevance to a positive emotion factor indicated by the current emotion information is increased by more than a threshold level from relevance to the positive emotion factor indicated by the previous emotion information.

The storage may store standard facial expression information indicating relations between negative emotion factors and empathetic facial expressions of the avatar that evoke empathy from the user, and the controller may update the facial expression information of the avatar based on the standard facial expression information, in response to a determination by the controller that relevance to a negative emotion factor indicated by the current emotion information is increased by more than a threshold level from relevance to the negative emotion factor indicated by the previous emotion information.

The standard facial expression information may include at least one empathetic facial expression corresponding to a negative emotion factor based on at least one of relevance to the negative emotion factor and an extent of change of the negative emotion factor.

The detector may collect at last one of vehicle driving information and in-vehicle situation information, and the controller may determine whether a user unit function performed by the user is stopped based on at least one of the vehicle driving information and the in-vehicle situation information, and initialize the facial expression information of the avatar in response to a determination that the user unit function is stopped.

The user unit function may include at least one of a driving function of the vehicle, an acceleration function of the vehicle, a deceleration function of the vehicle, a steering function of the vehicle, a multimedia playing function of the vehicle, calling performed by the user, and speaking of the avatar.

The storage may store information about correlations between biological signals of the user and emotion factors, and the controller may obtain the current emotion information of the user based on the information about correlations between biological signals of the user and emotion factors.

The behavior of the user may include hitting or tapping at least one of a steering wheel, a center console, and an arm rest, and the detector may include a pressure sensor or acoustic sensor installed in at least one of the steering wheel, the center console, and the arm rest, and detects a behavior of the user based on an output of the at least one of the pressure sensor and the acoustic sensor.

The storage may store information about correlations between behaviors of the user and emotion factors, and the controller may obtain the current emotion information of the user based on the information about correlations between behaviors of the user and emotion factors.

In accordance with another aspect of the present disclosure, a control method of a vehicle is provided. The control method of a vehicle includes detecting at least one of a biological signal of a user and a behavior of the user; obtaining current emotion information indicating a current emotional state of the user based on at least one of the biological signal of the user and the behavior of the user; comparing previous emotion information stored and the current emotion information to update facial expression information stored of an avatar; and displaying the avatar based on the updated facial expression information.

The facial expression information may include position and angle information of face elements of the avatar, and the face elements may include at least one of eyebrows, eyes, eyelids, nose, mouth, lips, cheeks, dimple, and chin of the avatar.

The updating of the facial expression information may include updating the facial expression information of the avatar to correspond to an emotion indicated by the current emotion information, in response to a determination that relevance to a positive emotion factor indicated by the current emotion information is increased by more than a threshold level from relevance to the positive emotion factor indicated by the previous emotion information.

The updating of the facial expression information may include updating the facial expression information of the avatar based on standard facial expression information indicating relations between negative emotion factors and empathetic facial expressions of the avatar that evoke empathy from the user, in response to a determination that relevance to a negative emotion factor indicated by the current emotion information is increased by more than a threshold level from relevance to the negative emotion factor indicated by the previous emotion information.

The standard facial expression information may include at least one empathetic facial expression corresponding to a negative emotion factor based on at least one of relevance to the negative emotion factor and an extent of change of the negative emotion factor.

The control method of a vehicle may further include collecting at last one of vehicle driving information and in-vehicle situation information, determining whether a user unit function performed by the user is stopped based on at least one of the vehicle driving information and the in-vehicle situation information, and initializing the facial expression information of the avatar in response to a determination that the user unit function is stopped.

The user unit function may include at least one of a driving function of the vehicle, an acceleration function of the vehicle, a deceleration function of the vehicle, a steering function of the vehicle, a multimedia playing function of the vehicle, calling performed by the user, and speaking of the avatar.

The obtaining of the current emotion information may include obtaining the current emotion information of the user based on information stored about correlations between biological signals of the user and emotion factors.

The detecting of the behavior of the user may include detecting a behavior of the user based on an output of at least one of a pressure sensor and an acoustic sensor, wherein at least one of the pressure sensor and the acoustic sensor is installed in at least one of a steering wheel, a center console, and an arm rest, and the behavior of the user may include hitting or tapping at least one of the steering wheel, the center console, and the arm rest.

The obtaining of the current emotion information may include obtaining the current emotion information of the user based on information stored about correlations between behaviors of the user and emotion factors.

### BRIEF DESCRIPTION OF THE DRAWINGS

The above and other objects, features and advantages of the present disclosure will become more apparent to those of ordinary skill in the art by describing in detail exemplary embodiments thereof with reference to the accompanying drawings, in which:

FIG. 1 shows the interior of a vehicle, according to an embodiment of the present disclosure;

FIG. 2 is a control block diagram of a vehicle, according to an embodiment of the present disclosure;

FIG. 3 shows information of correlations between biological signals and emotion factors, according to an embodiment of the present disclosure;

FIG. 4 shows the interior of a vehicle, according to an embodiment of the present disclosure;

FIG. 5 shows an emotion model, according to an embodiment of the present disclosure;

FIG. 6 shows changes in emotion of the user based on an emotion model, according to an embodiment of the present disclosure;

FIG. 7 shows standard facial expression information of an avatar, according to an embodiment of the present disclosure;

FIG. 8A shows an avatar corresponding to a positive emotional state, according to an embodiment of the present disclosure;

FIG. 8B shows an avatar corresponding to a negative emotional state, according to an embodiment of the present disclosure; and

FIG. 9 is a flowchart illustrating updating facial expression information of an avatar based on emotion information of a user in a control method of a vehicle, according to an embodiment of the present disclosure.

### DETAILED DESCRIPTION OF EXEMPLARY EMBODIMENTS

Like numerals refer to like elements throughout the specification. Not all elements of embodiments of the present disclosure will be described, and description of what are commonly known in the art or what overlap each other in the embodiments will be omitted.

It will be further understood that the term “connect” or its derivatives refer both to direct and indirect connection, and the indirect connection includes a connection over a wireless communication network.

The term “include (or including)” or “comprise (or comprising)” is inclusive or open-ended and does not exclude additional, unrecited elements or method steps, unless otherwise mentioned.

It is to be understood that the singular forms “a,” “an,” and “the” include plural references unless the context clearly dictates otherwise.

Furthermore, the terms, such as “˜part”, “˜block”, “˜member”, “˜module”, etc., may refer to a unit of handling at least one function or operation. For example, the terms may refer to at least one process handled by hardware such as field-programmable gate array (FPGA)/application specific integrated circuit (ASIC), etc., software stored in a memory, or at least one processor.

Reference numerals used for method steps are just used to identify the respective steps, but not to limit an order of the steps. Thus, unless the context clearly dictates otherwise, the written order may be practiced otherwise.

Embodiments of a vehicle and method for controlling the same will now be described in detail with reference to accompanying drawings.

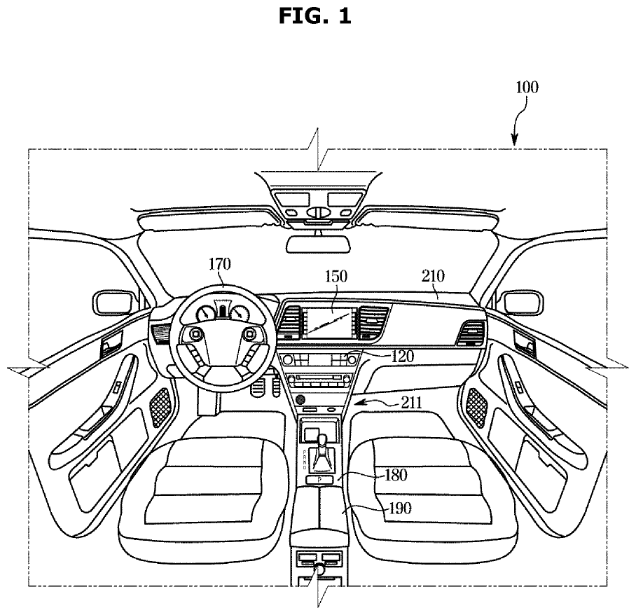

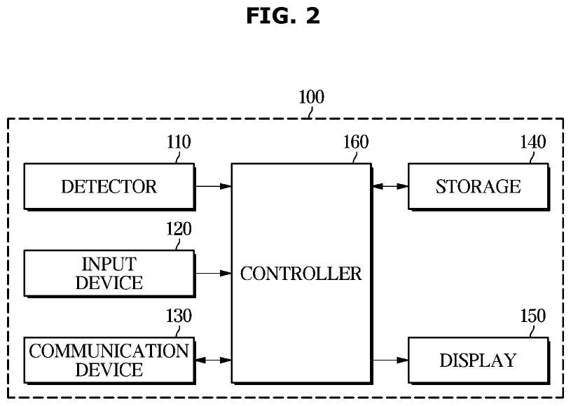

FIG. 1 shows the interior of a vehicle 100, according to an embodiment of the present disclosure, and FIG. 2 is a control block diagram of the vehicle 100, according to an embodiment of the present disclosure.

Referring to FIG. 1, a dashboard 210, an input device 120, a display 150, a steering wheel 170, a center console 180, and an arm rest 190 are provided inside the vehicle 100.

The dashboard 210 refers to a panel that separates the interior room of the vehicle 100 from the engine room and that has various parts required for driving installed thereon. The dashboard 210 is located in front of the driver seat and the passenger seat. The dashboard 210 may include a top panel, a center fascia 211, and a center console 180, and the like.

On the top panel of the dashboard 210, the display 150 may be installed. The display 150 may present various information in the form of images to the user of the vehicle 100. For example, the display 150 may visually present various information, such as maps, weather, news, various moving or still images, information regarding condition or operation of the vehicle 100, e.g., information about the air conditioner, etc.

Furthermore, the display 150 may display an avatar making different facial expressions based on the emotional state of the user. For example, when the emotion of the user is changed to be positive, the display 150 may display the avatar with a facial expression corresponding to the current emotion of the user under the control of a controller 160, which will be described later, and when the emotion of the user is changed to be negative, the display 150 may display the avatar with an empathetic facial expression to evoke empathy from the user. This will be described in more detail later.

The display 150 may be implemented with a commonly-used navigation system.

The display 150 may be installed inside a housing integrally formed with the dashboard 210 such that the display 105 may be exposed. Alternatively, the display 150 may be installed in the middle or the lower part of the center fascia 211, or may be installed on the inside of the windshield (not shown) or on the top of the dashboard 210 by means of a separate supporter (not shown). Besides, the display 150 may be installed at any position that may be considered by the designer.

Behind the dashboard 210, various types of devices, such as a processor, a communication module, a Global Positioning System (GPS) module, a storage, etc., may be installed. The processor installed in the vehicle 100 may be configured to control various electronic devices installed in the vehicle 100, and may serve as the controller 160. The aforementioned devices may be implemented using various parts, such as semiconductor chips, switches, integrated circuits, resistors, volatile or nonvolatile memories, printed circuit boards (PCBs), and/or the like.

The center fascia 211 may be installed in the middle of the dashboard 210, and may have an input device 120 for inputting various instructions related to the vehicle 100. The input device 120 may be implemented with mechanical buttons, knobs, a touch pad, a touch screen, a stick-type manipulation device, a trackball, or the like. The user may control many different operations of the vehicle 100 by manipulating the input device 120.

Alternatively, the input device 120 may be integrated with the display 150 and implemented using a touch screen.

The center console 180 is provided at the bottom of the center fascia 211 between the driver seat and the passenger seat. The center console 180 may have a gearshift lever, a container box, various input means, and the like. The container box and the input means may be omitted in some embodiments.

The vehicle 100 may further include the arm rest 190 located near the center console 180 for the user to rest his/her arm thereon.

The arm rest 190 is a part, on which the user may put his/her arm, to sit in a comfortable position inside the vehicle 100.

The steering wheel 170 is provided on the dashboard 210 in front of the driver seat.

The steering wheel 170 may be rotated in a certain direction by the user's manipulation, and accordingly, the front or back wheels of the vehicle 100 are rotated, thereby steering the vehicle 100. The steering wheel 170 may be equipped with a spoke connected to a rotation shaft and a rim coupled with the spoke. On the spoke, there may be an input means for inputting various instructions, and the input means may be implemented with mechanical buttons, knobs, a touch pad, a touch screen, a stick-type manipulation device, a trackball, or the like.

The steering wheel 170 may have a radial form to be conveniently manipulated by the driver, but is not limited thereto.

Referring to FIG. 2, the vehicle 100 in accordance with an embodiment may include a detector 110 for detecting at least one of a biological signal of a user, a behavior of the user, vehicle driving information, and in-vehicle situation information, an input device 120 for receiving an input from the user, a communication device 130 for sending or receiving information to or from an external server, a storage 140 for storing information about correlations between biological signals of users and emotion factors, standard facial expression information indicating a relationship between a negative emotion factor and an empathetic facial expression of an avatar that evokes empathy from the user, facial expression information of the avatar, and an emotion model, a display 150 for displaying the avatar, and a controller 160 for obtaining emotion information indicating an emotional state of the user based on at least one of a detected biological signal of the user and a detected behavior of the user, and updating the facial expression information of the avatar based on the emotion information.

In an embodiment, the detector 110 may detect a biological signal of the user and a behavior of the user. The controller 160, as will be described later, may obtain emotion information indicating an emotional state of the user based on at least one of the biological signal and the behavior of the user detected by the detector 110

The biological signal of the user may include at least one of a facial expression of the user, a skin response, a heart rate, brain waves, a state of facial expression, a state of voice, and a position of the pupil.

In an embodiment, the detector 110 includes at least one sensor to detect a biological signal of the user. The detector 110 may use the at least one sensor to detect and measure a biological signal of the user and send the result of measurement to the controller 160.

Accordingly, the detector 110 may include various sensors to detect and acquire biological signals of the user.

For example, the detector 110 may include at least one of a Galvanic Skin Response (GSR) measurer for measuring a state of the skin of the user, a heart rate (HR) measurer for measuring a heart rate, an Electroencephalogram (EEG) measurer for measuring brain waves of the user, a face analyzer integrated with an image sensor for capturing and analyzing a state of the facial expression of the user, a microphone for analyzing a state of the voice of the user, and an eye tracker integrated with an image sensor for tracking the position of the pupil of the user.

The detector 110 is not limited to having the aforementioned sensors, but may include any other sensor capable of measuring a biological signal of the user.

The behavior of the user may include hitting or tapping at least one of the steering wheel 170, the center console 180, and the arm rest 190.

In an embodiment, the detector 110 includes at least one sensor to detect the behavior of the user. The detector 110 may use the at least one sensor to detect and measure a behavior of the user and send the result of measurement to the controller 160.

Accordingly, the detector 110 may include various sensors to detect and acquire behaviors of the user.

The detector 110 may include at least one of a pressure sensor installed in at least one of the center console 180 and the arm rest 190 and an acoustic sensor installed in at least one of the center console 180 and the arm rest 190.

The detector 110 is not limited to having the aforementioned sensors, but may include any other sensor capable of measuring a behavior of the user.

Furthermore, the detector 110 in accordance with an embodiment may include a plurality of sensors for collecting driving information of the vehicle 100. The driving information of the vehicle 100 may include information about steering angle and torque of the steering wheel 170 manipulated by the user, instantaneous acceleration, the number of times and strength of the driver stepping on the accelerator, the number of times and strength of the driver stepping on the brake, speed of the vehicle 100, etc.

For this, the detector 110 may include a speed sensor and an inclination sensor. The detector 110 is not, however, limited to having the aforementioned sensors, but may include any other sensor capable of collect driving information of the vehicle 100.

The detector 110 may also collect information about an internal situation of the vehicle 100. The internal situation information (or in-vehicle information) may include whether a fellow passenger is on board, information about a conversation between the driver and a fellow passenger, multimedia play information through the display 150, information about a call performed by the user, etc.

For this, the detector 110 may include an acoustic sensor and a camera, each of which is equipped in the vehicle 100. The detector 110 is not limited to having the aforementioned sensors, but may include any other sensor capable of collecting the internal situation information of the vehicle 100.

In an embodiment, the input device 120 may receive an input from the user about standard facial expression information indicating relations between negative emotion factors and empathetic facial expressions of the avatar that evoke empathy from the user.

The standard facial expression information is information indicating relations between negative emotion factors of the user and empathetic facial expressions of the avatar, and the controller 160 may update the facial expression information of the avatar based on the standard facial expression information.

The standard facial expression information may be set by a manufacturer and stored in the storage 140, or set by an input from the user received through the input device 120 and stored in the storage 140, or received from an external server through the communication device 130 and stored in the storage 140.

The user may set a desired empathetic facial expression of the avatar through the input device 120 based on his/her negative emotional state, and set a relevance to and an extent of change in the negative emotion factor, which are the basis of an empathetic facial expression output.

In an embodiment, the communication device 130 may exchange information with the external server. Specifically, the communication device 130 may receive information about correlations between biological signals of the user and emotion factors, the standard facial expression information indicating relations between negative emotion factors and empathetic facial expressions of the avatar to evoke empathy from the user, and an emotion model from the external server.

Furthermore, the communication device 130 may receive information about a facial expression of the avatar output through the display 150.

The communication device 130 may communicate with the external server in various methods. It may transmit and receive information to and from the external server using various schemes, such as radio frequency (RF), wireless fidelity (Wi-Fi), Bluetooth, Zigbee, near field communication (NFC), ultra-wide band (UWB) communications, etc. The method or scheme for enabling communication with the external server is not limited thereto, but may be any kind of method that may enable communication with the external server.

Although the communication device 130 is shown in FIG. 2 as a single component to transmit or receive signals, it is not limited thereto, but may be implemented as separate transmitter (not shown) for transmitting signals and receiver (not shown) for receiving signals.

In an embodiment, the storage 140 may store an emotion model to determine emotional states of the user based on biological signals and behaviors of the user. The storage 140 may also store the information about correlations between biological signals of the user and emotion factors and correlations between behaviors of the user and emotion factors, and the information about correlations between biological signals of the user and emotion factors and correlations between behaviors of the user and emotion factors may be used to determine an emotional state of the user, as will be described later.

The storage 140 may also store emotion information indicating an emotional state of the user determined by the controller 160.

The storage 140 may also store the standard facial expression indicating relations between negative emotion factors and empathetic facial expressions of the avatar that evoke empathy from the user, facial expression information of the avatar, and various information about the vehicle 100.

The storage 140 may be implemented with at least one of a non-volatile memory device, such as cache, read only memory (ROM), programmable ROM (PROM), erasable programmable ROM (EPROM), electrically erasable programmable ROM (EEPROM), a volatile memory device, such as random access memory (RAM), or a storage medium, such as hard disk drive (HDD) or compact disk (CD) ROM, without being limited thereto, to store the various information.

In accordance with an embodiment, the display 150 may display the avatar. Specifically, the display 150 may visually present the avatar, based on the facial expression information of the avatar updated by the controller 160.

The display 150 may include a panel, and the panel may be one of a cathode ray tube (CRT) panel, a liquid crystal display (LCD) panel, a light emitting diode (LED) panel, an organic LED (OLED) panel, a plasma display panel (PDP), and a field emission display (FED) panel.

The display 150 may also include a touch panel for receiving touches of the user as inputs. In this case where the display 150 includes the touch panel, the display 150 may serve as the input device 120 as well.

In accordance with an embodiment, the controller 160 may obtain emotion information indicating an emotional state of the user based on at least one of the biological signal and the behavior of the user detected by the detector 110.

The controller 160 may also control the storage 140 to store the obtained emotion information. The emotion information stored may be compared with emotion information measured later.

The obtained emotion information may include arousal corresponding to an arousal level of the emotional state, and valence corresponding to a positive level or negative level of the emotional state. This will be described in more detail later.

The controller 160 may compare the obtained current emotion information with the previous emotion information stored in the storage 140 to update the facial expression information of the avatar.

The current emotion information indicates a current emotional state of the user, and the previous emotion information indicates a previous emotional state of the user obtained before the current emotion information and stored in the storage 140.

The controller 160 may compare the previous emotion information and the current emotion information to identify an extent of change in the emotional state of the user, and update the facial expression information of the avatar based on the extent of change in the emotional state of the user.

Specifically, the controller 160 may update the facial expression information of the avatar to correspond to an emotion indicated by the current emotion information, when the relevance to the positive emotion factor indicated by the current emotion information is increased by more than a threshold level from the relevance to the positive emotion factor indicated by the previous emotion information.

In other words, the controller 160 may update the facial expression information of the avatar to represent an expression identical or similar to the emotional state indicated by the current emotion information.

Furthermore, the controller 160 may update the facial expression information of the avatar based on the standard facial expression information, when the relevance to the negative emotion factor indicated by the current emotion information is increased by more than a threshold level from the relevance to the negative emotion factor indicated by the previous emotion information.

For example, the controller 160 may update the facial expression information of the avatar based on the standard facial expression information indicating relations between negative emotion factors and empathetic facial expressions of the avatar that evoke empathy from the user, to represent an empathetic facial expression to evoke empathy from the user. This will be described in more detail later.

The controller 160 may control the display 150 to display the avatar based on the updated facial expression information.

Accordingly, the user may watch the avatar with a facial expression indicated by the updated facial expression information. In this way, the user may be given and watch an avatar with a facial expression that reflects the emotional state of the user, thus feeling friendlier and more empathetic to the avatar as compared with an avatar with an uniform facial expression.

In accordance with an embodiment, the controller 160 may continuously update the facial expression information of the avatar. Specifically, the controller 160 may keep obtaining emotion information of the user, and based on the emotion information, update the facial expression information of the avatar.

In this regard, the controller 160 may continue to update the facial expression information of the avatar to match a user unit function. Specifically, the controller 160 may update the facial expression information of the avatar based on the user unit function performed by the user while the user unit function is maintained.

When the user unit function is stopped, the controller 160 may control the facial expression information of the avatar to be initialized to represent an initially set facial expression of the avatar.

More specifically, the controller 160 may determine whether the user unit function performed by the user is stopped based on at least one of the detected driving information of the vehicle and in-vehicle situation information, and initialize the facial expression information of the avatar when the user unit function is stopped.

The user unit function may include a driving function of the vehicle 100, an acceleration function of the vehicle 100, a deceleration function of the vehicle 100, and a steering function of the vehicle 100. Furthermore, the user unit function may include a multimedia playing function, a call performed by the user, and a conversation of the user.

In other words, the user unit function may include a driving function of the vehicle 100, an acceleration function of the vehicle 100, a deceleration function of the vehicle 100, a steering function of the vehicle 100, and a multimedia playing function in the vehicle 100, all of which are related to the function of the vehicle 100.

The user unit function may also include a call performed by the user and a conversation between the user and a fellow passenger, which are related to the speaking of the user.

The user unit function may also include the speaking of the avatar about a particular content and the speaking of the avatar about question and answer, which are related to the speaking of the avatar. For example, the avatar displayed on the display 150 may speak about a particular content and particular question and answer through a speaker (not shown) equipped in the vehicle 100. The controller 160 may control the speaker to output the speaking of the avatar.

Specifically, the controller 160 may reflect situations of the vehicle 100 and user for each user unit function performed by the user by updating the facial expression information of the avatar for the user unit function, and accordingly, the user of the vehicle 100 may be given an avatar, to which the user may feel friendlier and more empathetic than to an avatar with a uniform facial expression. This will be described in more detail later.

The controller 160 may include at least one non-transitory memory for storing a program for carrying out the aforementioned and following operations, and at least one processor for executing the program. In a case that the memory and the processor are each provided in the plural, they may be integrated in a single chip or physically distributed.

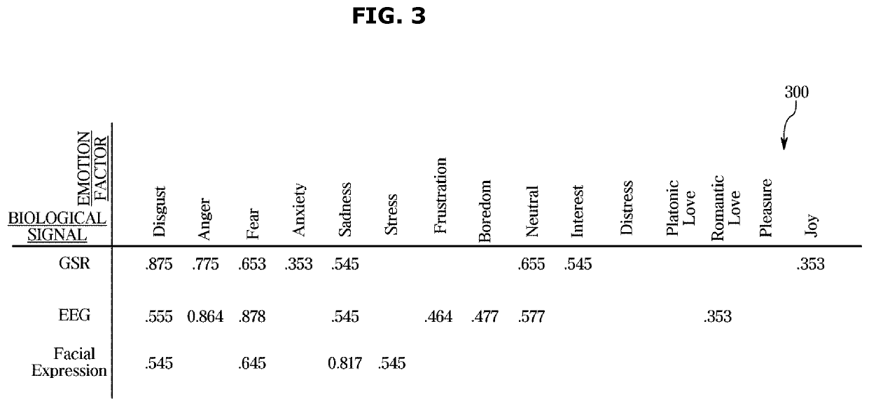

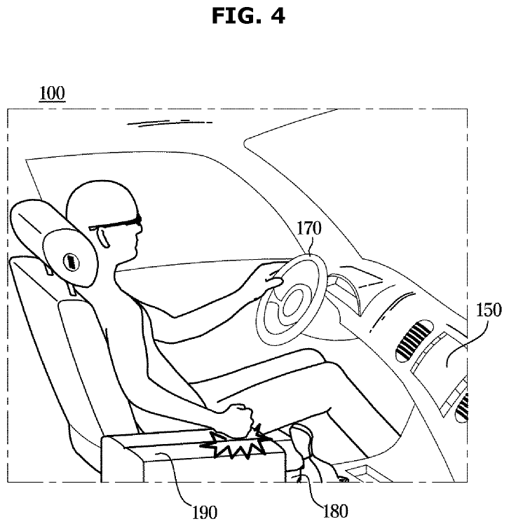

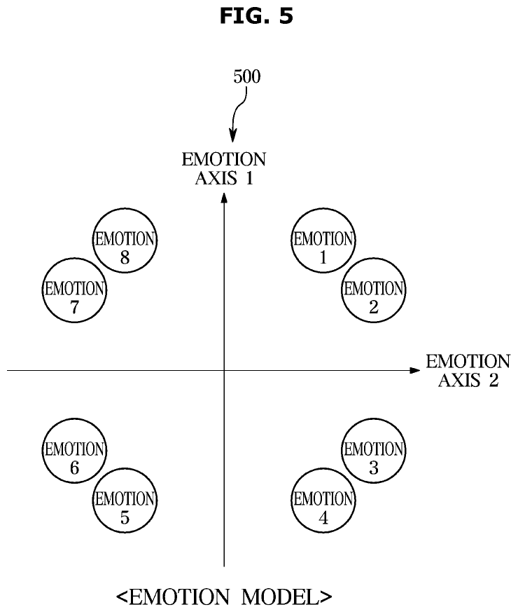

FIG. 3 shows information 300 about correlations between biological signals and emotion factors, according to an embodiment of the present disclosure, FIG. 4 shows the interior of the vehicle 100, according to an embodiment of the present disclosure, and FIG. 5 shows an emotion model, according to an embodiment of the present disclosure.

Referring to FIG. 3, the controller 160 may obtain emotion information of the user using a biological signal of the user detected by the detector 110 and the information 300 about correlations between biological signals of the user and emotion factors stored in the storage 140.

It is seen that values of correlations of a GSR signal with disgusting and angry emotion factors are 0.875 and 0.775, respectively, which may be interpreted that the GSR signal has high relevance to disgusting and angry emotion factors. Accordingly, the biological signal of the user collected by a GSR measurer may become a basis to determine that the emotion of the user corresponds to a feeling of anger or a feeling of disgust.

In a case of a joy emotion factor, the value of a correlation with the GSR signal, 0.353, is relatively low, which may be interpreted that the joy emotion factor has low relevance to the GSR signal.

Furthermore, values of correlations of an EEG signal with angry and fearful emotion factors are 0.864 and 0.878, respectively, which may be interpreted that the EEG signal has higher relevance to the angry and fearful emotion factors than to other emotion factors. Accordingly, a biological signal of the user collected by an EEG measurer may become a basis to determine that the emotion of the user corresponds to anger or fear.

In this way, the controller 160 may obtain an emotional state of the user using the information 300 about correlations between biological signals of the user and emotion factors. Pieces of the information shown in FIG. 3 are only experimental results, which may vary by experimental condition.

Referring to FIG. 4, in accordance with an embodiment, the controller 160 may obtain emotion information indicating an emotional state of the user based on a behavior of the user detected by the detector 110. Specifically, the controller 160 may obtain emotion information indicating an emotional state of the user based on a behavior of the user detected by the detector 110 and information about correlations between behaviors of the user and emotion factors stored in the storage 140.

The behaviors of the user may include hitting, tapping, shaking, and gripping at least one of the steering wheel 170, the center console 180, and the arm rest 190.

The user may be put in various situations while driving the vehicle 100 and have various feelings depending on the situation. The user may hit, tap, or shake an internal part of the vehicle 100 based on various emotions felt during the driving of the vehicle 100.

For example, when the vehicle 100 is stuck in traffic, the user of the vehicle 100 may feel angry and hit or shake the steering wheel 170 with anger. In another example, when the user of the vehicle 100 is stuck in traffic and running late for an engagement, the user of the vehicle 100 may feel nervous and accordingly, tap the steering wheel 170 with his/her fingers.

Accordingly, in an embodiment of the present disclosure, the controller 160 may identify an emotional state of the user corresponding to a behavior of the user detected by the detector 110 based on the information about correlations between behaviors of the user and emotion factors, and based on the result of identification, obtain the emotion information.

The information about correlations between behaviors of the user and emotion factors indicates an emotion factor corresponding to a behavior of the user. The information about correlations between behaviors of the user and emotion factors may be stored in the storage 140, and the controller 160 may determine an emotional state of the user based on the information.

In other words, the information about correlations between behaviors of the user and emotion factors includes behavior information of the user that triggers the corresponding emotion factor.

For example, behavior information of the user corresponding to angry, excited, and irritated emotion factors may include at least one of hit information generated when the user hits an object with his/her hand or foot and shake (or vibration) information generated when the user shakes an object with his/her hand.

Furthermore, behavior information of the user corresponding to bored, tired, frustrated, disappointed, and depressed emotion factors may include grip information generated when the user strongly grips an object with his/her hand.

Moreover, behavior information of the user corresponding to nervous emotion factor may include tap information generated when the user taps an object with his/her fingers.

The object, to which an emotion of the user is expressed, is what is placed near the user, including the steering wheel 170, the center console 180, and the arm rest 190.

In an embodiment, the detector 110 may include pressure sensors installed at the steering wheel 170, center console 180, and arm rest 190 and detect a behavior of the user based on an output of the pressure sensor. The pressure sensor may include a capacitive touch sensor and any other sensor, without limitations, capable of measuring pressure.

In an embodiment, the storage 140 may store a reference pressure to recognize hitting on each of the steering wheel 170, the center console 180, and the arm rest 190, a reference pressure and reference time to recognize gripping associated with shaking of each of the steering wheel 170, the center console 180, and the arm rest 190, and a reference pressure and reference frequency to recognize tapping on each of the steering wheel 170, the center console 180, and the arm rest 190.

Specifically, the detector 110 may determine whether there is hitting, shaking, tapping, or griping each of the steering wheel 170, the center console 180, and the arm rest 190, by comparing the magnitude of the detected pressure, pressure-applied period, and frequency of application of the pressure with the reference pressure, reference time and reference frequency of each behavior stored in the storage 140.

In other words, the detector 110 may detect a behavior of the user based on an output of the pressure sensor and the reference pressure, reference time, and reference frequency of each behavior stored in the storage 140.

In an embodiment, the detector 110 may include acoustic sensors installed at the steering wheel 170, center console 180, and arm rest 190 and detect a behavior of the user based on an output of the acoustic sensor. The acoustic sensor may include a microphone and any other sensor, without limitations, capable of measuring acoustic waves.

In an embodiment, the storage 140 may store a reference acoustic pattern to recognize hitting on each of the steering wheel 170, the center console 180, and the arm rest 190, and a reference acoustic pattern to recognize tapping on each of the steering wheel 170, the center console 180, and the arm rest 190.

The reference acoustic pattern may vary by body part of the user or material of the object, and include frequency, volume, and number of times.

Specifically, the detector 110 may determine acoustic waves corresponding to detected vibrations and volume, create an acoustic pattern of the determined acoustic waves, and determine whether there is hitting or tapping on each of the steering wheel 170, the center console 180, and the arm rest 190, by comparing the created acoustic pattern with the reference acoustic pattern stored in the storage 140.

In other words, the detector 110 may detect a behavior of the user based on an output of the acoustic sensor and the reference acoustic pattern of each behavior stored in the storage 140.

In this way, the controller 160 may obtain emotion information of the user based on a behavior of the user detected by the detector 110 and the information about correlations between behaviors of the user and emotion factors stored in the storage 140.

Referring to FIG. 5, an emotion model 500 is classifications of the emotion of the user in a graph, which appear depending on biological signals and behaviors of the user. The emotion model 500 divides the emotion of the user with respect to predetermined emotion axes.

The emotion axes may be determined based on emotions measured by sensors.

For example, one emotion axis, axis 1, may be arousal that may be measured by the GSR or EEG, and the other emotion axis, axis 2, may be valence that may be measured by the user hitting an object and/or by analyzing voice and face of the user.

The arousal may represent a level of alertness, excitement, or activation of an emotional state, and the valence may represent a positive or negative level of the emotional state.

A point at which the emotion axis representing the arousal, which is axis 1, and the emotion axis representing the valence, which is axis 2, intersect, represents a neutral state of the arousal and valence, at which an emotional state of the user is neutral without leaning toward positivity or negativity.

When an emotion of the user has a high level of positivity and a high level of arousal, the emotion may be classified into emotion 1 or 2. On the other hand, when an emotion of the user has a negative level of positivity, i.e., a level of negativity, and a high level of arousal, the emotion may be classified into emotion 3 or 4.

The emotion model 500 may be the Russell emotion model. The Russell emotion model 500 may be represented in a two dimensional xy-plane graph, classifying emotions into eight categories of joy at 0 degree, excitement at 45 degrees, arousal at 90 degrees, misery at 135 degrees, displeasure at 180 degrees, depression at 225 degrees, sleepiness at 270 degrees, and relaxation at 315 degrees. The eight categories have a total of 28 emotions, similar ones of which belong to each of eight categories.

The emotion model 500 may be received from the external server through the communication device 130 and stored in the storage 140. The controller 160 may map the emotion information of the user obtained based on at least one of a biological signal of the user and a behavior of the user onto the emotion model 500, and update the facial expression information of the avatar based on the emotion information of the user mapped onto the emotion model 500.

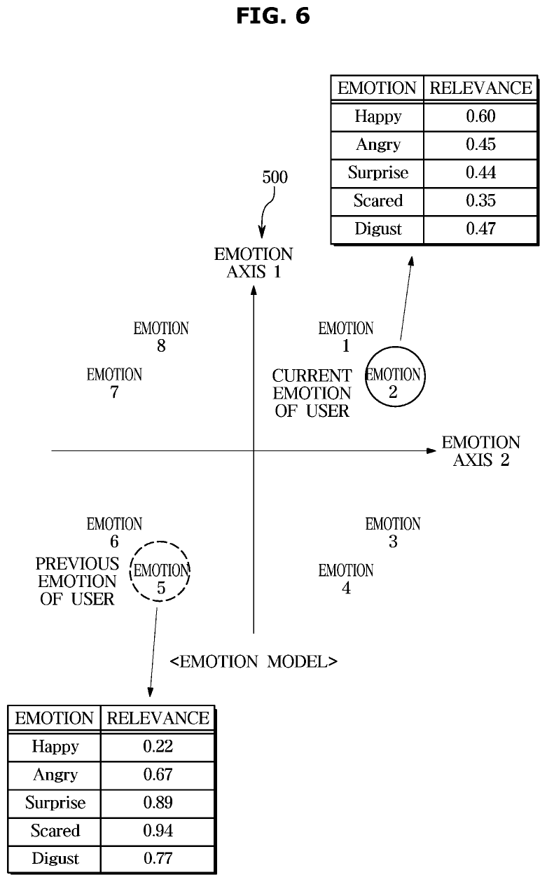

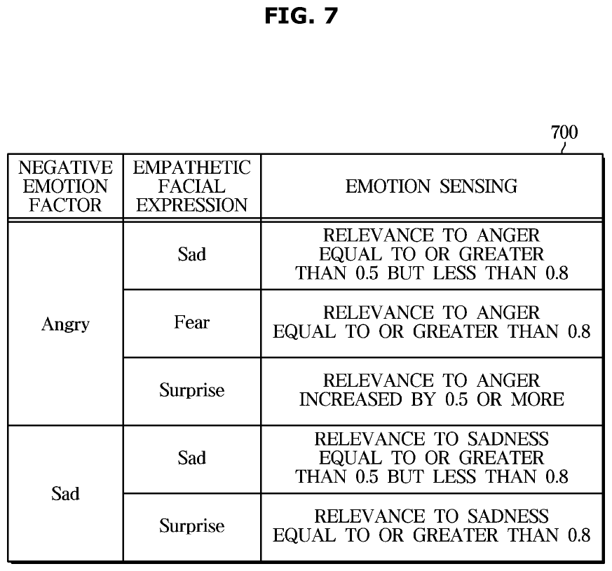

FIG. 6 shows changes in emotion of the user based on the emotion model 500, according to an embodiment of the present disclosure, and FIG. 7 shows standard facial expression information of an avatar, according to an embodiment of the present disclosure.

Referring to FIG. 6, the controller 160 may obtain current emotion information from a biological signal of the user and a behavior of the user and determine that the current emotion of the user corresponds to emotion 2 on the emotion model.

The storage 140 may store previous emotion information obtained before the current emotion information. The controller 160 may fetch the previous emotion information from the storage 140, and based on the previous emotion information, determine that the previous emotion information corresponds to emotion 5 on the emotion model.

The emotion information obtained by the controller 160 from a biological signal of the user and a behavior of the user may be represented by the relevance to each emotion factor indicating an emotional state of the user. For example, if the emotion information is represented by relevance 0.22 to a happy emotion factor and relevance 0.67 to an angry emotion factor, the emotion information may indicate that an emotional state of the user corresponds to anger rather than happiness.

As such, the emotion information may be represented by relevance to each emotion factor that indicates an emotional state of the user, the relevance having values ranging from 0 to 1.

The controller 160 may extract an emotion factor that has an influence on the current emotion of the user, and among emotion factors that influence the current emotion of the user, positive emotion factors may belong to a first group and negative emotion factors may belong to a second group.

In FIG. 6, emotion factors each having an influence on the current emotion of the user are extracted as happiness, anger, surprise, fear, and disgust. In this case, happiness may be classified as a positive emotion factor and may belong to the first group, and anger, surprise, fear, and disgust may belong to the second group as negative emotion factors.

The controller 160 may compare the obtained current emotion information with the previous emotion information stored in the storage 140 to update the facial expression information of the avatar.

The current emotion information indicates a current emotional state of the user, and the previous emotion information indicates a previous emotional state of the user obtained before the current emotion information and stored in the storage 140.

The controller 160 may compare the previous emotion information and the current emotion information to identify an extent of change in the emotional state of the user, and update the facial expression information of the avatar based on the extent of change in the emotional state of the user.

Specifically, the controller 160 may update the facial expression information of the avatar to correspond to an emotion indicated by the current emotion information, when the relevance to the positive emotion factor indicated by the current emotion information is increased by more than a threshold level from the relevance to the positive emotion factor indicated by the previous emotion information.

For example, as shown in FIG. 6, it is seen that the relevance to the happy emotion factor belonging to the first group is increased by 0.38 from that of the previous emotion information. The controller 160 may compare the relevance to a positive emotion factor included in the previous emotion information and the relevance to the positive emotion factor included in the current emotion information, and determine that the happy emotion factor is increased by 0.38.

The threshold level may be a value to determine an extent of change in the emotional state of the user and may have a default value of 0.05, which may be changed by settings of the user through the input device 120.

If the threshold level is set to be high, the frequency of updating the facial expression information of the avatar may be lower than in the case of setting the threshold level to be low.

In an embodiment, the controller 160 may update the facial expression information of the avatar to correspond to an emotion indicated by the current emotion information, when the relevance to the positive emotion factor indicated by the current emotion information is increased by more than the threshold level from the relevance to the positive emotion factor indicated by the previous emotion information.

In other words, the controller 160 may update the facial expression information of the avatar to represent an expression identical or similar to the emotional state indicated by the current emotion information.

For example, if the happy emotion factor belonging to the first group is increased by 0.38, which is more than the threshold level, from that of the previous emotion information, the controller 160 may determine that the relevance to the positive emotion factor indicated by the current emotion information is increased by more than the predetermined threshold level from the relevance to the positive emotion factor indicated by the previous emotion information, and update the facial expression information of the avatar to make a facial expression identical or similar to an emotional state indicated by the current emotion information.

Furthermore, the controller 160 may update the facial expression information of the avatar based on the standard facial expression information, when the relevance to the negative emotion factor indicated by the current emotion information is increased by more than a threshold level from the relevance to the negative emotion factor indicated by the previous emotion information.

Referring to FIG. 7, the storage 140 may store standard facial expression information 700 indicating relations between negative emotion factors and empathetic facial expressions of the avatar that evoke empathy from the user.

The standard facial expression information 700 is information indicating relations between negative emotion factors of the user and empathetic facial expressions of the avatar, and the controller 160 may update the facial expression information of the avatar based on the standard facial expression information 700.

The standard facial expression information 700 may be set by a manufacturer and stored in the storage 140, or set by an input from the user received through the input device 120 and stored in the storage 140, or received from an external server through the communication device 130 and stored in the storage 140.

The standard facial expression information 700 may include empathetic facial expressions of the avatar that correspond to the negative emotion factors of the emotion of the user, as shown in FIG. 7. In other words, the standard facial expression information 700 may include at least one empathetic facial expression that corresponds to a negative emotion factor based on at least one of the relevance to the negative emotion factor and an extent of change of the negative emotion factor.

For example, in a case that the negative emotion factor corresponds to anger, the standard facial expression information 700 may set up and store a facial expression corresponding to sadness when the relevance to the angry emotion factor is equal to or more than 0.5 but less than 0.8. When the extent of change of the relevance to the angry emotion factor is equal to or more than 0.5, the standard facial expression information 700 may set up and store an empathetic facial expression that corresponds to surprise.

Pieces of the information shown in FIG. 7 are only experimental results, which may vary by settings. In other words, the standard facial expression information 700 may set up and store at least one empathetic expression that corresponds to each negative emotion factor. Furthermore, the empathetic facial expressions correspond to facial expressions to evoke empathy from the user, including sad, surprised, scared, and disgusting facial expressions.

The standard facial expression information 700 may include an empathetic facial expression set to be identical to the facial expression of the user corresponding to the negative emotion factor, and also include an empathetic facial expression set to represent a positive emotion opposite the facial expression of the user corresponding to the negative emotion factor.

Furthermore, the empathetic expressions may be continuously updated and included in the standard facial expression information 700. For example, the controller 160 may control the detector 110 to detect at least one of a biological signal of the user and a behavior of the user after updating the facial expression information of the avatar to an empathetic facial expression based on the standard facial expression information 700, obtain emotion information of the user based on the at least one of the biological signal of the user and the behavior of the user, and determine whether an emotion indicated by the obtained emotion information is changed to be more positive than the emotion before the facial expression information of the avatar is updated to the empathetic expression.

If the emotion indicated by the obtained emotion information is changed to be more positive than the emotion before the facial expression information of the avatar is updated to the empathetic expression, the controller 160 may not update the standard facial expression information 700 to maintain the set empathetic expression.

Otherwise, if the emotion indicated by the obtained emotion information is changed to be more negative than the emotion before the facial expression information of the avatar is updated to the empathetic expression, the controller 160 may update the standard facial expression information 700 to update the set empathetic expression to an expression that may further evoke empathy. In other words, the controller 160 may continuously update empathetic facial expressions by comparing emotions of the user before and after updating of the facial expression information of the avatar.

The controller 160 may determine whether the relevance to the negative emotion factor indicated by the current emotion information is increased by more than a threshold level from the relevance to the negative emotion factor indicated by the previous emotion information.

Furthermore, the controller 160 may determine a type, relevance and an extent of change of the negative emotion factor indicated by the current emotion information, determine a corresponding empathetic facial expression based on the standard facial expression information 700 and update the facial expression information of the avatar, when the relevance to the negative emotion factor indicated by the current emotion information is increased by more than a threshold level from the relevance to the negative emotion factor indicated by the previous emotion information.

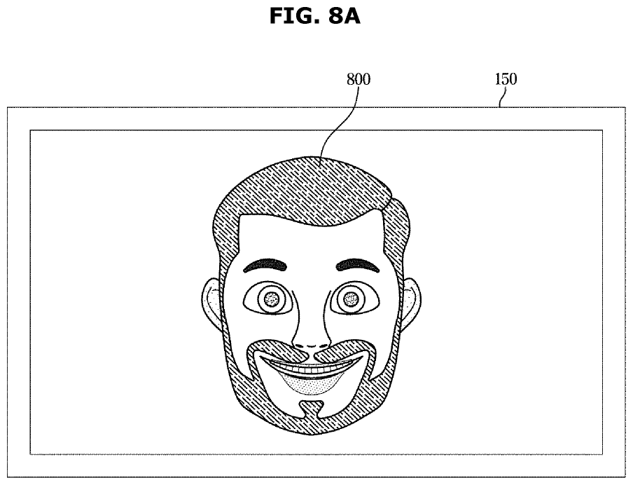

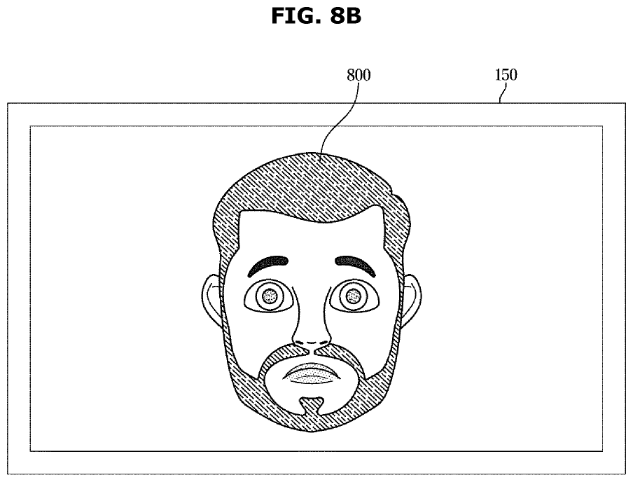

FIG. 8A shows an avatar corresponding to a positive emotional state, according to an embodiment of the present disclosure, and FIG. 8B shows an avatar corresponding to a negative emotional state, according to an embodiment of the present disclosure.

Referring to FIGS. 8A and 8B, the controller 160 may control the display 150 to display an avatar 800 based on the updated facial expression information.

The facial expression information of the avatar 800 may include information about positions and angles of face elements.

The controller 160 may update the facial expression information of the avatar 800 by comparing the previous emotion information and the current emotion information and updating information about positions and angles of face elements included in the facial expression information.

The face elements of the avatar 800 may include at least one of eyebrows, eyes, eyelids, nose, mouth, lips, cheeks, dimple, and chin.

The controller 160 may update the facial expression information of the avatar 800 by updating the information about position and angle of each of the face elements of the avatar 800.

The updated facial expression information may represent the facial expression of the avatar 800 in a positive emotional state or in a negative emotional state depending on the updating direction.

For example, the controller 160 may determine that the relevance to the positive emotion factor indicated by the current emotion information is increased by more than a set threshold level from the relevance to the positive emotion factor indicated by the previous emotion information, and update the facial expression information of the avatar to correspond to an emotion indicated by the current emotion information.

At this time, the controller 160 may update the facial expression information of the avatar 800 to make a facial expression in a positive emotional state to correspond to the emotion indicated by the current emotion information.

Specifically, the controller 160 may update the facial expression information by updating the information about a position and angle of the mouth to raise the corners of the mouth. Furthermore, the controller 160 may update the facial expression information by updating the information about a position and angle of a dimple to create the dimple. Moreover, the controller 160 may update the facial expression information by updating the information about positions and angles of the eyes to form a smile with the eyes. Updating of the facial expression information is not limited thereto, but may be implemented in any manners that may make a facial expression in a positive emotional state.

Accordingly, as shown in FIG. 8A, the controller 160 may control the display 150 to display the avatar 800 based on the updated facial expression information of the avatar 800 to correspond to an emotion indicated by the current emotion information.

Furthermore, the controller 160 may determine that the relevance to the negative emotion factor indicated by the current emotion information is increased by more than a threshold level from the relevance to the negative emotion factor indicated by the previous emotion information, and update the facial expression information of the avatar to correspond to a negative emotion factor indicated by the current emotion information based on the standard facial expression information.

At this time, the controller 160 may update the facial expression information of the avatar 800 to make an empathetic facial expression to correspond to the negative emotion factor indicated by the current emotion information.

Specifically, the controller 160 may update the facial expression information by updating the information about a position and angle of the mouth to drop the corners of the mouth. Furthermore, the controller 160 may update the facial expression information by updating the information about a position and angle of the dimple not to create the dimple. Moreover, the controller 160 may update the facial expression information by updating the information about positions and angles of the eyes to make a sad expression with the eyes. Updating of the facial expression information is not limited thereto, but may be implemented in any manners that may make an empathetic facial expression.

Accordingly, as shown in FIG. 8B, the controller 160 may control the display 150 to display the avatar 800 based on the facial expression information of the avatar 800 updated to the empathetic facial expression that corresponds to a negative emotion factor indicated by the current emotion information.

Accordingly, the user may watch the avatar 800 with a facial expression indicated by the updated facial expression information. The user may watch the avatar 800 with a facial expression indicated by the facial expression information updated in a dynamic manner or a real time manner. In this way, the user may be given and watch the avatar with a facial expression reflecting the emotional state of the user, thus feeling friendlier and more empathetic to the avatar 800 as compared to an avatar with an uniform facial expression.

In accordance with an embodiment, the controller 160 may continuously update the facial expression information of the avatar 800. Specifically, the controller 160 may keep obtaining emotion information of the user, and based on the emotion information, update the facial expression information of the avatar 800.

In this regard, the controller 160 may continue to update the facial expression information of the avatar 800 to match the user unit function. Specifically, the controller 160 may update the facial expression information of the avatar 800 based on the user unit function performed by the user while the user unit function is maintained.

When the user unit function is stopped, the controller 160 may control the facial expression information of the avatar 800 to be initialized to indicate an initially set facial expression of the avatar 800.

More specifically, the controller 160 may determine whether the user unit function performed by the user is stopped based on at least one of the detected driving information of the vehicle and in-vehicle situation information, and initialize the facial expression information of the avatar 800 when the user unit function is stopped.

The user unit function may include a driving function of the vehicle 100, an acceleration function of the vehicle 100, a deceleration function of the vehicle 100, and a steering function of the vehicle 100. Furthermore, the user unit function may include a multimedia playing function, a call performed by the user, and a conversation of the user.

In other words, the user unit function may include a driving function of the vehicle 100, an acceleration function of the vehicle 100, a deceleration function of the vehicle 100, a steering function of the vehicle 100, and a multimedia playing function in the vehicle 100, all of which are related to the function of the vehicle 100.

The user unit function may also include a call performed by the user and a conversation between the user and a fellow passenger, which are related to the speaking of the user.

The user unit function may also include the speaking of the avatar about a particular content and the speaking of the avatar about question and answer, which are related to the speaking of the avatar. For example, the avatar displayed on the display 150 may speak about a particular content and particular question and answer through a speaker (not shown) equipped in the vehicle 100. The controller 160 may control the speaker to output the speaking of the avatar.

Specifically, the controller 160 may reflect situations of the vehicle 100 and user for each user unit function performed by the user by updating the facial expression information of the avatar 800 for the user unit function, and accordingly, the user of the vehicle 100 may be given the avatar 800, to which the user may feel friendlier and more empathetic than to an avatar with a uniform facial expression.

A control method of the vehicle 100 in accordance with an embodiment will now be described. The vehicle 100 may be applied in describing the control method of the vehicle 100. What are described above with reference to FIGS. 1 to 8 may also be applied in the control method of the vehicle 100 without being specifically mentioned.

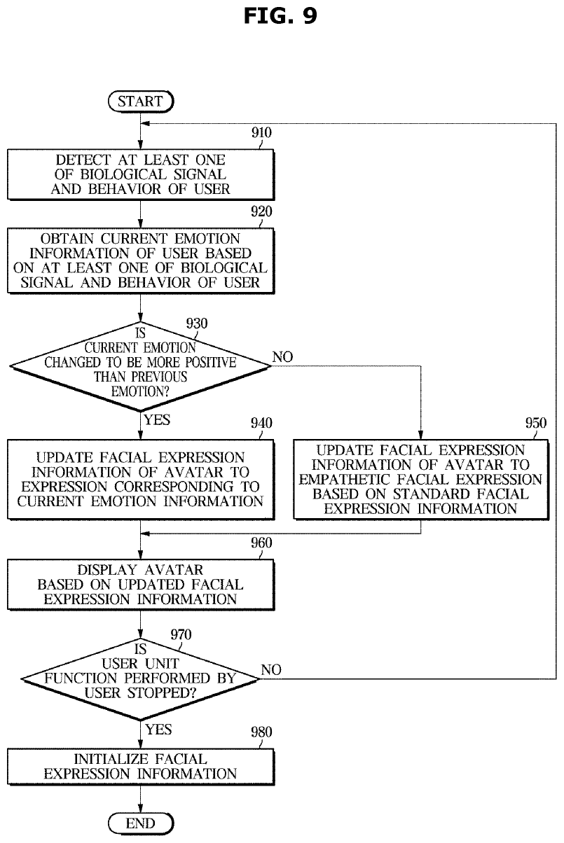

FIG. 9 is a flowchart illustrating updating facial expression information of the avatar 800 based on emotion information of a user in a control method of the vehicle 100, according to an embodiment of the present disclosure.

In an embodiment, the vehicle 100 detects at least one of a biological signal of the user and a behavior of the user, in 910. Specifically, the controller 160 may control the detector 110 to detect at least one of a biological signal of the user and a behavior of the user.

In an embodiment, the detector 110 may detect a biological signal of the user and a behavior of the user.

The biological signal of the user may include at least one of a facial expression of the user, a skin response, a heart rate, brain waves, a state of facial expression, a state of voice, and a position of the pupil.

In an embodiment, the detector 110 includes at least one sensor to detect a biological signal of the user. The detector 110 may use the at least one sensor to detect and measure a biological signal of the user and send the result of measurement to the controller 160. Accordingly, the detector 110 may include various sensors to detect and acquire biological signals of the user.

The behavior of the user may include hitting or tapping at least one of the steering wheel 170, the center console 180, and the arm rest 190.

In an embodiment, the detector 110 includes at least one sensor to detect the behavior of the user. The detector 110 may use the at least one sensor to detect and measure a behavior of the user and send the result of measurement to the controller 160. Accordingly, the detector 110 may include various sensors to detect and acquire behaviors of the user.

Specifically, the detector 110 may include at least one of a pressure sensor installed in at least one of the center console 180 and the arm rest 190 and an acoustic sensor installed on at least one of the center console 180 and the arm rest 190.

In an embodiment, the vehicle 100 obtains current emotion information of the user based on a biological signal of the user and a behavior of the user, in 920. Specifically, the controller 160 of the vehicle 100 may obtain current emotion information of the user based on the detected biological signal and behavior of the user detected by the detector 110.

Specifically, the controller 160 may obtain current emotion information of the user using a biological signal of the user detected by the detector 110 and the information 300 about correlations between biological signals of the user and emotion factors stored in the storage 140.

Furthermore, the controller 160 may obtain current emotion information of the user using a behavior of the user detected by the detector 110 and the information about correlations between behaviors of the user and emotion factors stored in the storage 140.

The controller 160 may compare the obtained current emotion information with the previous emotion information stored in the storage 140 to update the facial expression information of the avatar 800.

Specifically, when the current emotion is changed to be more positive than the previous emotion in 930, the vehicle 100 updates the facial expression information of the avatar 800 to an expression corresponding to the current emotion information in 940.

Specifically, the controller 160 may update the facial expression information of the avatar 800 to correspond to an emotion indicated by the current emotion information, when the relevance to the positive emotion factor indicated by the current emotion information is increased by more than a threshold level from the relevance to the positive emotion factor indicated by the previous emotion information.

In other words, the controller 160 may update the facial expression information of the avatar 800 to represent an expression identical or similar to the emotional state indicated by the current emotion information.

When the current emotion is not changed to be more positive than the previous emotion in 930, the vehicle 100 updates the facial expression information of the avatar 800 to an empathetic expression based on the standard facial expression information 700 in 950.

Specifically, the controller 160 may update the facial expression information of the avatar 800 based on the standard facial expression information 700, when the relevance to the negative emotion factor indicated by the current emotion information is increased by more than a threshold level from the relevance to the negative emotion factor indicated by the previous emotion information.

For example, the controller 160 may update the facial expression information of the avatar 800 based on the standard facial expression information 700 indicating relations between negative emotion factors and empathetic facial expressions of the avatar 800 that evoke empathy from the user, to represent an empathetic facial expression to evoke empathy from the user.

The controller 160 displays the avatar 800 based on the updated facial expression information, in 960. Specifically, the controller 160 may control the display 150 to display the avatar 800 based on the updated facial expression information.

The display 150 may display a screen of the avatar 800 having a facial expression indicated by the facial expression information updated under the control of the controller 160.

When the user unit function performed by the user is stopped in 970, the vehicle 100 initializes the facial expression information in 980.

In accordance with an embodiment, the controller 160 may continuously update the facial expression information of the avatar 800. Specifically, the controller 160 may keep obtaining emotion information of the user, and based on the emotion information, update the facial expression information of the avatar 800.

In this regard, the controller 160 may continue to update the facial expression information of the avatar 800 to match the user unit function. Specifically, the controller 160 may update the facial expression information of the avatar 800 based on the user unit function performed by the user while the user unit function is maintained.

When the user unit function is stopped, the controller 160 may control the facial expression information of the avatar 800 to be initialized to indicate an initially set facial expression of the avatar 800.

More specifically, the controller 160 may determine whether the user unit function performed by the user is stopped based on at least one of the detected driving information of the vehicle and in-vehicle situation information, and initialize the facial expression information of the avatar 800 when the user unit function is stopped.

The user unit function may include a driving function of the vehicle 100, an acceleration function of the vehicle 100, a deceleration function of the vehicle 100, and a steering function of the vehicle 100. Furthermore, the user unit function may include a multimedia playing function, a call performed by the user, and a conversation of the user.

Specifically, the controller 160 may reflect situations of the vehicle 100 and user for each user unit function performed by the user by updating the facial expression information of the avatar 800 for the user unit function, and accordingly, the user of the vehicle 100 may be given the avatar 800, to which the user may feel friendlier and more empathetic than to an avatar with a uniform facial expression.

According to an embodiment of the present disclosure, a vehicle and control method thereof may provide an avatar and determine a facial expression of the avatar to evoke empathy from the user, thereby giving and triggering more friendly and positive feeling to the user.

Meanwhile, the embodiments of the present disclosure may be implemented in the form of recording media for storing instructions to be carried out by a computer. The instructions may be stored in the form of program codes, and when executed by a processor, may generate program modules to perform operation in the embodiments of the present disclosure. The recording media may correspond to non-transitory, or transitory, computer-readable recording media.

The computer-readable recording medium includes any type of recording medium having data stored thereon that may be thereafter read by a computer. For example, it may be a ROM, a RAM, a magnetic tape, a magnetic disk, a flash memory, an optical data storage device, etc.

Several embodiments have been described above, but a person of ordinary skill in the art will understand and appreciate that various modifications can be made without departing the scope of the present disclosure. Thus, it will be apparent to those ordinary skilled in the art that the true scope of technical protection is only defined by the following claims.

What is claimed is:

1. A vehicle comprising:
a detector configured to detect at least one of a biological signal of a user and a behavior of the user;
a storage configured to store previous emotion information of the user and facial expression information of an avatar;
a controller configured to obtain current emotion information indicating a current emotional state of the user based on at least one of the biological signal of the user and the behavior of the user, and compare the previous emotion information and the current emotion information to update the facial expression information; and
a display configured to display the avatar based on the updated facial expression information.

2. The vehicle of claim 1, wherein the facial expression information comprises position and angle information of face elements of the avatar, and the face elements comprise at least one of eyebrows, eyes, eyelids, nose, mouth, lips, cheeks, dimple, and chin of the avatar.

3. The vehicle of claim 2, wherein the controller is configured to update the facial expression information of the avatar to correspond to an emotion indicated by the current emotion information, in response to a determination by the controller that relevance to a positive emotion factor indicated by the current emotion information is increased by more than a threshold level from relevance to the positive emotion factor indicated by the previous emotion information.

4. The vehicle of claim 2, wherein:
the storage is configured to store standard facial expression information indicating relations between negative emotion factors and empathetic facial expressions of the avatar that evoke empathy from the user, and
the controller is configured to update the facial expression information of the avatar based on the standard facial expression information, in response to a determination by the controller that relevance to a negative emotion factor indicated by the current emotion information is increased by more than a threshold level from relevance to the negative emotion factor indicated by the previous emotion information.

5. The vehicle of claim 4, wherein the standard facial expression information comprises at least one empathetic facial expression corresponding to a negative emotion factor based on at least one of relevance to the negative emotion factor and an extent of change of the negative emotion factor.

6. The vehicle of claim 1, wherein:
the detector is configured to collect at last one of vehicle driving information and in-vehicle situation information, and
the controller is configured to determine whether a user unit function performed by the user is stopped based on at least one of the vehicle driving information and the in-vehicle situation information, and initialize the facial expression information of the avatar in response to a determination that the user unit function is stopped.

7. The vehicle of claim 6, wherein the user unit function comprises at least one of a driving function of the vehicle, an acceleration function of the vehicle, a deceleration function of the vehicle, a steering function of the vehicle, a multimedia playing function of the vehicle, calling performed by the user, and speaking of the avatar.

8. The vehicle of claim 1, wherein:
the storage is configured to store information about correlations between biological signals of the user and emotion factors, and
the controller is configured to obtain the current emotion information of the user based on the information about correlations between biological signals of the user and emotion factors.

9. The vehicle of claim 1, wherein:
the behavior of the user comprises hitting or tapping at least one of a steering wheel, a center console, and an arm rest, and
the detector comprises a pressure sensor or acoustic sensor installed in at least one of the steering wheel, the center console, and the arm rest, and detects a behavior of the user based on an output of the at least one of the pressure sensor and the acoustic sensor.

10. The vehicle of claim 9, wherein:
the storage is configured to store information about correlations between behaviors of the user and emotion factors, and
the controller is configured to obtain the current emotion information of the user based on the information about correlations between behaviors of the user and emotion factors.

11. A control method of a vehicle comprising:
detecting at least one of a biological signal of a user and a behavior of the user;
obtaining current emotion information indicating a current emotional state of the user based on at least one of the biological signal of the user and the behavior of the user;
comparing previous emotion information stored and the current emotion information to update facial expression information stored of an avatar; and
displaying the avatar based on the updated facial expression information.

12. The control method of claim 11, wherein:
the facial expression information comprises position and angle information of face elements of the avatar, and
the face elements comprise at least one of eyebrows, eyes, eyelids, nose, mouth, lips, cheeks, dimple, and chin of the avatar.

13. The control method of claim 12, wherein the updating of the facial expression information comprises updating the facial expression information of the avatar to correspond to an emotion indicated by the current emotion information, in response to a determination that relevance to a positive emotion factor indicated by the current emotion information is increased by more than a threshold level from relevance to the positive emotion factor indicated by the previous emotion information.

14. The control method of claim 12, wherein the updating of the facial expression information comprises
updating the facial expression information of the avatar based on standard facial expression information indicating relations between negative emotion factors and empathetic facial expressions of the avatar that evoke empathy from the user, in response to a determination that relevance to a negative emotion factor indicated by the current emotion information is increased by more than a threshold level from relevance to the negative emotion factor indicated by the previous emotion information.

15. The control method of claim 14, wherein the standard facial expression information comprises
at least one empathetic facial expression corresponding to a negative emotion factor based on at least one of relevance to the negative emotion factor and an extent of change of the negative emotion factor.

16. The control method of claim 11, further comprising:
collecting at last one of vehicle driving information and in-vehicle situation information;
determining whether a user unit function performed by the user is stopped based on at least one of the vehicle driving information and the in-vehicle situation information; and
initializing the facial expression information of the avatar in response to a determination that the user unit function is stopped.

17. The control method of claim 16, wherein the user unit function comprises
at least one of a driving function of the vehicle, an acceleration function of the vehicle, a deceleration function of the vehicle, a steering function of the vehicle, a multimedia playing function of the vehicle, calling performed by the user, and speaking of the avatar.

18. The control method of claim 11, wherein the obtaining of the current emotion information comprises
obtaining the current emotion information of the user based on information stored about correlations between biological signals of the user and emotion factors.

19. The control method of claim 11, wherein:
the detecting of the behavior of the user comprises detecting a behavior of the user based on an output of at least one of a pressure sensor and an acoustic sensor,
at least one of the pressure sensor and the acoustic sensor is installed in at least one of a steering wheel, a center console, and an arm rest, and
the behavior of the user comprises hitting or tapping at least one of the steering wheel, the center console, and the arm rest.

20. The control method of claim 19, wherein the obtaining of the current emotion information comprises
obtaining the current emotion information of the user based on information stored about correlations between behaviors of the user and emotion factors.
